(19) United States
(12) Patent Application Publication
(10) Pub. No.: US 2007/0265999 A1
(43) Pub. Date: Nov. 15, 2007

(54) Search Performance and User Interaction Monitoring of Search Engines

(76) Inventors: Einat Amitay, Shimshit (IL); Naama Kraus, Haifa (IL); Ronny Lempel, Haifa (IL); Yael Petruschka, Haifa (IL); Aya Soffer, Haifa (IL)

Correspondence Address: Stephen C. Kaufman;IBM CORPORATION, Intellectual Property Law Dept., P.O. Box 218, Yorktown Heights, NY, 10598, US

(21) Appl. No.: 11/383,265

(22) Filed: May 15, 2006

(51) Int. Cl. G06F 17/30

(52) U.S. Cl. 707/2

(57) ABSTRACT

A system for monitoring search performance and user interaction is provided in the form of a utility (300) including a plurality of monitoring components (302), each for dynamic monitoring of an aspect of searching a collection of documents. An analyzer module (303) analyzes the dynamic monitoring and identifies problems or difficulties in the search performance or user interactions. An output (301), which may be in the form of a display interface, provides information regarding the search performance and user interaction including one or more of: reasoning, improvement suggestions, reports, and problem alerts. The analyzer module (302) compares the dynamic monitoring to benchmark search engine conduct and document collection state.

### FIELD OF THE INVENTION

This invention relates to the field of information search and retrieval. In particular, the invention relates to search performance and user interaction monitoring of search engines.

### BACKGROUND OF THE INVENTION

Search is the most effective way to find information on the Internet as well as on enterprise intranets and corporate Web sites. High quality search improves user satisfaction and supports more informative decisions. In order to deliver high quality search, one must be able to measure and quantify search quality. However, the person responsible for the overall utility of the search engine (SE) in an enterprise is often overlooked by current enterprise SE designers.

Enterprise search differs from Web search by being organization-specific with a target audience found uniquely in this organization. In enterprise search a document collection that is indexed is authored and tailored with the organization's primary tasks in mind. Results are displayed considering security and privacy issues exclusively dictated by the organization installing the SE. Different organizations also deal with different notions of correctness that are task specific and mean different levels of rightness in different organizations. The dissimilarity between Web search and enterprise search is thus very clear and many companies have started working toward dedicated enterprise SEs.

Like other enterprise middleware, the enterprise SE is usually installed as is, out of the box. Tools are usually provided for an administrator to setup the search service, specify the content to be crawled and indexed, perhaps define a taxonomy or search scope, define the physical resources the SE can use, etc. Many organizations employ several professionals, whose roles are to maintain and support the SE on the one end and to satisfy and respond to the needs of the organization's users on the other end. This team has the exclusive responsibility for the deployment of the SE while the developers of the SE, who have intimate knowledge of the way the SE operates, are only called upon when the deployers of the SE are not getting the results they expect from the solution. As part of this process the default and recommended settings of the SE may be altered, the initially well engineered ranking scheme may be skewed. User satisfaction studies, which are often part of the job description of this team, are often conducted yearly and only influence the SE settings in its next release or fix-pack.

Since the team of people installing and controlling the engine, do not understand the specifics of the SE that they are using, they require support and guidance from the developers. For example, how can the team improve the SE's ranking given their organization needs? By adding weights to their unique and proprietary metadata? By adding weights to specific terms each department adds to the end of documents? By adding weights to specific title terms that are taken out of a controlled vocabulary? And how is this change affecting their users? Is the change sensible? Or is it just that people assumed there is more content found in titles but now they understand it is not so?

Consequently, the developers of search solutions find themselves facing not real users or real data but organizational messengers or mediators that tell the SE developers, what their internal users are telling them.

The problem solved is the lack of a central utility for digesting SE monitoring data as well as collection coverage. This problem is particularly highlighted in enterprise SEs as discussed above; however, the proposed solution also applies to Web SEs.

There have been several attempts to solve separate, individual aspects of this problem. For example, query difficulty prediction, identifying reformulation sessions, IBM's SurfAid (IBM and SurfAid are trade marks of International Business Machines Corporation), and Google's Zeitgeist (GOOGLE and ZEITGEIST are trade marks of Google, Inc.). However, there has not been any attempt to provide a comprehensive solution that utilizes the accumulated knowledge acquired by monitoring the various SE aspects.

### SUMMARY OF THE INVENTION

According to a first aspect of the present invention there is provided a system for monitoring search performance and user interaction, comprising: a plurality of monitoring components, each for dynamic monitoring of an aspect of searching a collection of documents; an analyzer module for analyzing the dynamic monitoring and identifying problems or difficulties in the search performance or user interaction; and an output providing information regarding the search performance and user interaction.

According to a second aspect of the present invention there is provided a method for monitoring search performance and user interaction, comprising: dynamic monitoring of a plurality of aspects of searching a collection of documents; analyzing the dynamic monitoring and identifying problems or difficulties in the search performance or user interactions; and providing information regarding the search performance and user interaction.

According to a third aspect of the present invention there is provided a computer program product stored on a computer readable storage medium, comprising computer readable program code means for performing the steps of: dynamic monitoring of a plurality of aspects of searching a collection of documents; analyzing the dynamic monitoring and identifying problems or difficulties in the search performance or user interactions; and providing information regarding the search performance and user interaction.

According to a fourth aspect of the present invention there is provided a method of providing a service to a customer over a network for monitoring search performance and user interaction, the service comprising: dynamic monitoring of a plurality of aspects of searching a collection of documents; analyzing the dynamic monitoring and identifying problems or difficulties in the search performance or user interactions; and providing information regarding the search performance and user interaction.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram of a known computer system in which the present invention may be implemented;

FIG. 2 is a block diagram of a first embodiment of a system in accordance with the present invention;

FIG. 3 is a block diagram of a second embodiment of a system in accordance with the present invention;

FIG. 4 is a block diagram showing inputs and output of a system in accordance with the present invention;

FIGS. 5A and 5B are representations of a utility display interface in accordance with the present invention; and

FIGS. 6A to 6D are representations of a utility display interface in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

There are many search engines on the Internet each with its own method of operating. Generally search engines include: at least one spider or crawler application which crawls across the Internet gathering information; a database which contains all the information the crawler gathers in the form of an index or catalogue; and a search tool for users to search through the database. Search engines extract and index information differently and also return results in different ways.

Internet technology is also used to create private corporate networks call Intranets. Intranet networks and resources are not available publicly on the Internet and are separated from the rest of the Internet by a firewall which prohibits unauthorised access to the Intranet. Intranets also have search engines which search within the limits of the Intranet.

In addition, search engines are provided in individual Web sites, for example, of large corporations. A search engine is used to index and retrieve the content of only the Web site to which it relates and associated databases and other resources.

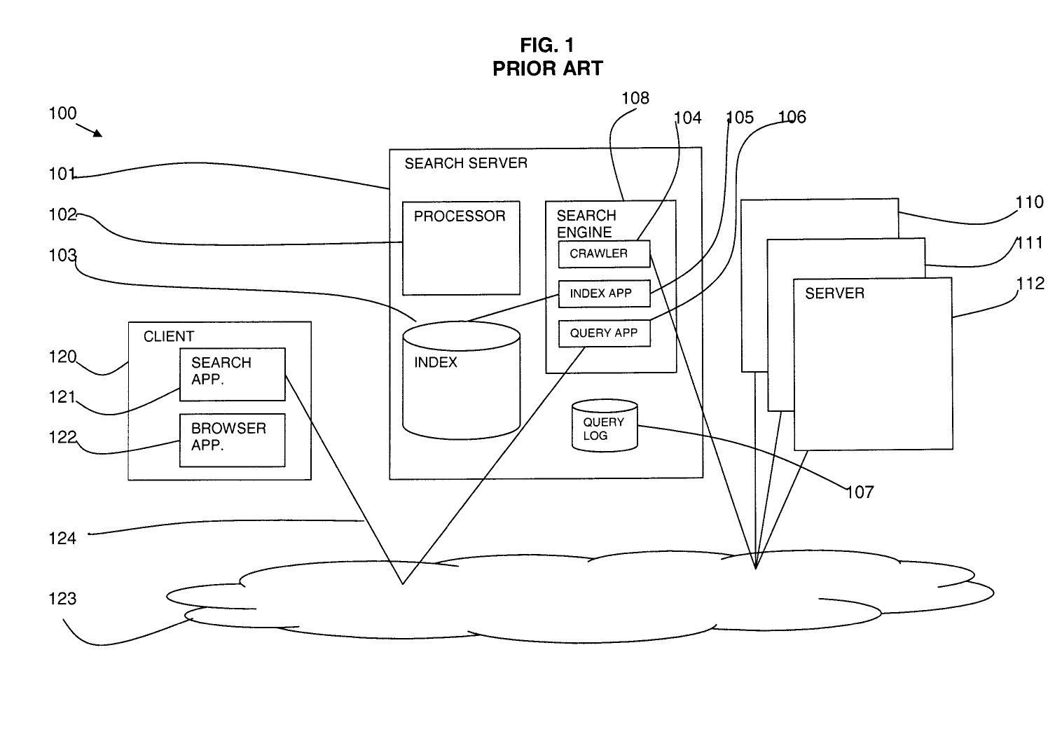

Referring to FIG. 1, an example embodiment of a search engine system 100 as known in the prior art is shown. A server system 101 is provided generally including a central processing unit (CPU) 102, with an operating system, and a database 103. A server system 101 provides a search engine 108 including: a crawler application 104 for gathering information from servers 110, 111, 112 via a network 123; an application 105 for creating an index or catalogue of the gathered information in the database 103; and a search query application 106.

The index stored in the database 103 references URLs (Uniform Resource Locator) of documents in the servers 110, 111, 112 with information extracted from the documents.

The search query application 106 receives a query request 124 from a search application 121 of a client 120 via the network 123, compares it to the entries in the index stored in the database 103 and returns the results in HTML pages. When the client 120 selects a link to a document, the client's browser application 122 is routed straight to the server 110, 111, 112 which hosts the document.

The search query application 106 keeps a query log 107 of the search queries received from clients using the search engine 103. Alternatively, a query log may be kept separately from the search engine 100 by saving queries in a log first and then sending the information to the search engine 100.

A utility is described for analyzing and enhancing the performance and well-being of a search engine and searchable collection. The utility identifies difficulties and provides reasoning and/or improvement suggestions encompassing various search engine (SE) aspects. For example, the SE aspects may include user satisfaction, user interaction, content coverage, search accuracy, and overall SE wellness. The utility aims to provide added value in the form of instructions and jobs for the collection and search engine owners.

Also, the utility may be provided as a stand-alone, comprehensive component in a search environment, which is targeted to monitor, analyze and report quality and performance in that environment.

The utility particularly applies to enterprise search solutions, although it could equally be applied to Web search solutions. In an enterprise, the responsibility of the overall wellbeing of the SE is held by mediators (namely, search administrators, search application developers and content managers) and not by the SE developers and therefore, a utility as described is required to aid the mediators in obtaining the best performance from the SE in their enterprise.

In order to be as flexible as possible and generic as possible, enterprise SEs can be provided as a basic API search engine that allows better mix-and-match software and locally developed add-ons. This means that the user interface (UI) is usually detached from the SE and there may sometimes be several task-specific applications issuing queries to the same SE at the same time. Such a structure decouples essential information about the SE user community from the search processing unit itself. Information such as search results clickthrough, which provides an immediate and measurable user feedback, may not find its way into the SE but will remain in the UI logging system. This means that only the user who has control over the UI can make good use of data such as clickthrough or user ID. In consideration of this potential decoupling of the UI from the enterprise SE, the utility is proposed as a meta-tool which comprises a single mechanism for monitoring the search process continuously and for suggesting improvements where possible.

The utility monitors the various aspects of searching a collection, identifies difficulties (e.g., insufficient collection coverage, unsatisfactory findability, and trends in user dissatisfaction behaviour), and provides reasoning and/or improvement suggestions. Reports can be tailored periodically, and alerts are generated when a problem is encountered. The utility also uses benchmarks of “normal” search engine conduct, and the collection's “desired” state. The utility may include a central display for presenting aspects of the output to the end user.

The utility is implemented as a generic tool intended to be incorporated into a search environment, regardless of the SE used.

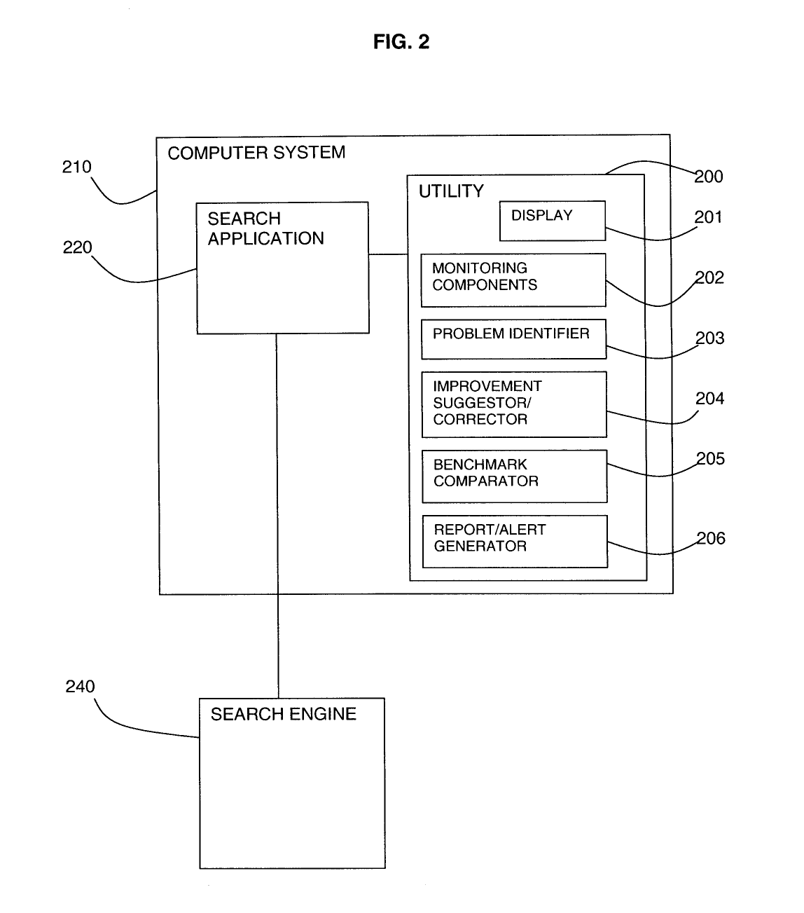

Referring to FIG. 2, a first embodiment of the proposed utility 200 is illustrated. In this embodiment, the utility 200 is provided as a local utility, created and owned by a search application 220 and provided on the same computer system 210. The search application 220 makes queries to a search engine 240 and feeds its local utility 200 with search information passing through it and extracts statistics from the utility 200. The search application 220 has full and exclusive control over its utility 200.

The utility 200 includes a display 201 for viewing the output of the utility 200. The utility 200 includes monitoring components 202, a problem identifier module 203, an improvement suggestor and corrector module 204, a benchmark comparator 205, and a report or alert generator 206. FIG. 2 shows an example implementation of the utility 200, other implementation may contain a selection of the components 202-206 or additional components to those shown in FIG. 2.

A local utility 200 is created by a search application 220 and resides on the same machine 210. The search application 220 pushes and pulls information by directly activating utility operations. No other application has access to the local utility 200. The local utility 200 maintains information originating exclusively from its owning search application 220.

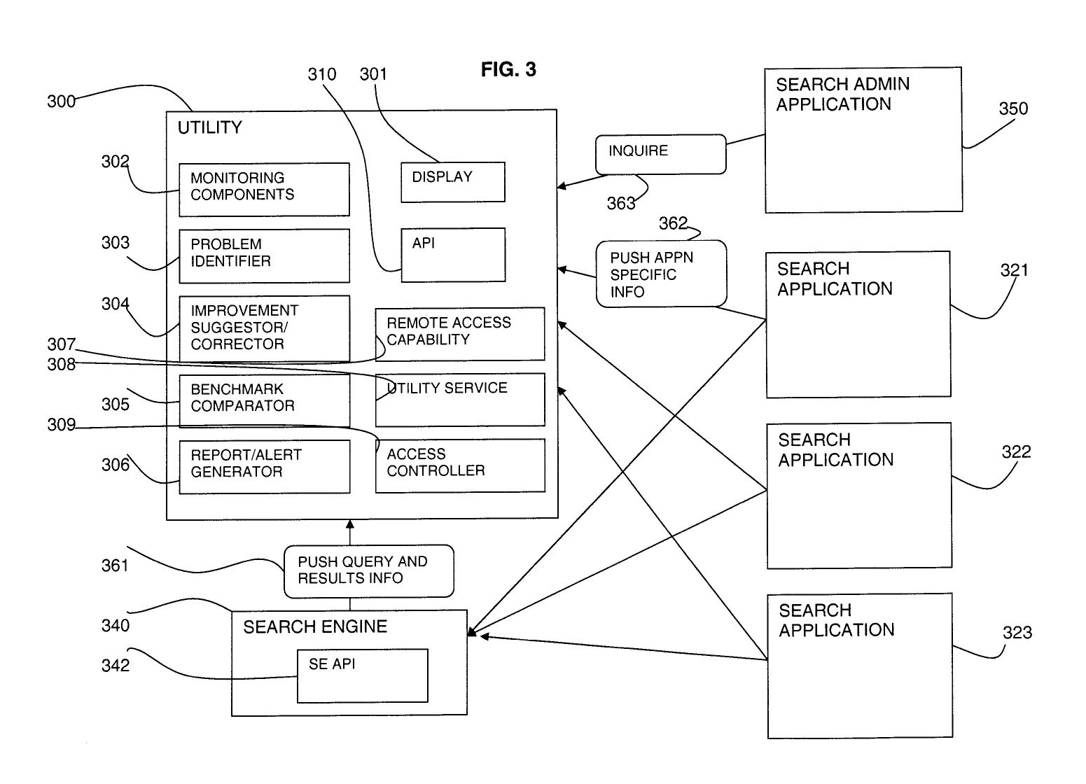

Referring to FIG. 3, a second embodiment of the proposed utility 300 is illustrated. In this embodiment, the utility 300 is provided as a remote utility. Reference numbers corresponding to those used in FIG. 2 are used for the same features in FIG. 3.

The utility 300 is provided as an application remote to one or more search applications 321, 322, 323, a search engine 340 and a search administration application 350. The utility 300 may be local to one of the above but is accessible remotely by all the search components.

Although the utility 300 is targeted towards search applications 321-323, there is also a need to enable monitoring at the level of the organization's system administrator. In many cases, the SE 340 and the system administration are managed by the same department. However, it could very well be the case that system administration is a separate entity which performs administrative tasks, and that the search activity itself resides and maintained elsewhere. On the other hand, it is essential that the system administrator who has the overall responsibility for quality issues within the organization be given the ability to monitor search activity and quality. What is required for satisfying such duality is the capability to access a utility 300 remotely. Thus, a utility 300 can be fed with search information by entities like search applications 321-323 or even the SE backend itself 340, and then be queried for search quality statistics by entities such as a search administration application 350 of the system administrator. Each entity could potentially run on a different machine. The remote utility architecture externalizes a variety of configuration options for building search quality monitoring service on top of it.

In order to support the remote utility 300 working mode, the following three needs have to be satisfied:
1. The first and most obvious one is to provide remote access capabilities 307 to the utility 300. By remote access we mean creating a utility, destroying it and performing utility operations, namely pushing and pulling information.
2. Second, there should be an entity, referred to as a utility service 308 that maintains a group of sub-utilities, each one of them monitors a different collection in the system.
3. Third, since any entity in the system gains remote access to the various aspects of the utility 300, an access control mechanism 309 is required. This mechanism 309 provides means for specifying which entity is allowed to perform what action on which aspect of the utility 300.

The utility service 308 is responsible for enforcing the access control restrictions. Client applications 321-323 that wish to access a certain utility 300 remotely, first contact the utility service 308 to get a remote utility handle. The remote utility 300 implements the utility API 310 but in practice serves as a proxy representing the specific utility aspect. The client application 321-323 is now able to perform actions on the remote utility instance as if it was a local utility. Under the hood, the remote utility implementation transfers the requests to the utility service 308. The utility service 308 identifies the relevant utility aspect, performs the requested operation if authorized and sends the response back to the client application 321-323 over the network.

In this configuration, the SE 340 pushes query and result information 361 into the utility 300 since the whole traffic of search activity streams through it. Search applications 321-323 push application-specific information 362 like user feedback and clickthroughs. The search administrator application 350 pulls quality statistics 363 from the utility 300 thus giving the administrator a view of the quality of the search system. A search application 321-323 client still has the possibility of creating its own local utility 200 on its client machine.

The utility 300 exposes an API 310 that defines the way it receives input and returns output. Through the API 310, applications 321-323 are able to feed the utility 300 with data to track, and to retrieve search quality insights. In order to enable the utility's easy integration into any search application 321-323, the utility API 310 may use under the assumption that the underneath SE 340 uses a standard API 342 (for example, the IBM standard Search and Index API.).

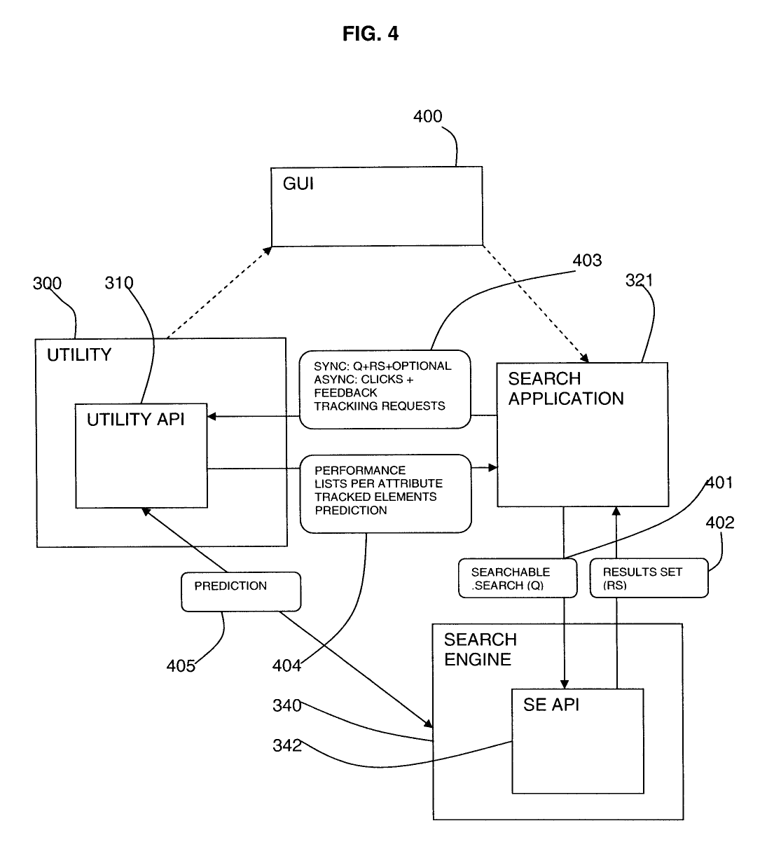

Referring to FIG. 4, an example representation of the types of input and output supported by the utility's API 310 are shown. A search application 321 makes an input to the search engine API 342 in the form of a search query (Q) 401. The search engine API 342 outputs a result set (RS) 402 to the search application 321.

Inputs 403 of the utility API 310 consist of three groups: synchronous, asynchronous, and specific tracking requests.
The first synchronous group includes search queries and result sets that the application 321 or SE 340 should register to the utility 300 immediately after query issuing.
The asynchronous group includes information gathered by search application 321 at a later time yet can be helpful for the utility missions. Such information is, for example, user feedback and clickthrough.
The specific tracking requests group gives the SE mediator an opportunity to fine tune the utility 300 to their specific needs. The utility aspect could be instructed at any time to track an item of interest such as a specific query or sub query, a specific document or domain, and the general results' page views.

Inputs 403 are fed to the utility 300 using a streaming interface. This way the utility 300 gets full responsibility over the quantity and identity of saved information. Moreover, since the search application 321 is released from concerns of log size, it can transfer to the utility 300 all available search information. Alternatively, batches of query logs may be used as input.

Outputs 404 of the utility 300 consist of statistics and performance reports, logs of items per attributes, and tracking reports. Additional utility outputs 404 lean on advanced technologies such as topic detection, session detection, query difficulty prediction, and content estimation.

Inputs and outputs to the utility API 310 are also provided from the search engine 340 in the form of predictions 405 of results.

FIG. 4 shows an embodiment in which query and result inputs are provided by the search application 321. This is not always the case, and the described system is not limited to inputs from the search application 321. For example, in the remote application, this information comes directly from the search engine. All the information is given to the utility 300 through its generic APIs 310 regardless of the exact source of inputs. One exception is the prediction information 405 which is dependent on a direct link to the search engine 340.

Two modes of utility output are envisaged.
One is a user initiated mode, meaning that the user of the utility 300 initiates a request for specific quality information he is interested in, like “provide me with all popular queries”. A graphical user interface (GUI) 400 may be provided for user interaction with the utility 300.
The other is a utility initiated mode meaning that the utility itself initiates a notification such as an alert about some quality problem it has identified.

In order to implement the utility's API 310, the following utility infrastructure modules are implemented as part of the monitoring components 302:
Recent items tracker
Significant items tracker
Global events queue
Query clustering component
Query difficulty predictor
Content estimator
Query reformulation sessions detector

The utility 300 is responsible for the control and management of saved information. Hence, all components are designed to use limited and bounded computational resources (RAM and secondary storage). In addition, each module is designed as a stand-alone component which has no co-dependencies with other components. Each component defines its interface, namely the input it expects and the output it provides. This way, modules can be added, omitted or replaced easily. It also enables flexible deployment, allowing SE moderators to choose the level of quality monitoring they desire based on resource availability.

The recent and significant items tracker is a simple sliding window for tracking most recent items. The significant items tracker is a more complex component whose manifestation in the utility is usually a “time-skewed frequent item tracker” meaning that frequency is tracked, but newly seen items are more important than older ones. Both are used for producing recency and popularity information of different items. They are designed in a general way so they can track any type of item (like a query, a topic or a user session).

The global events queue aggregates times and counts of events like queries and sessions. It returns the statistics per any requested time slice like average query processing time, search load per second and average search session length. Again, this module supports tracking statistics of any type of event.

The query clustering component identifies topics of interest and topics trends using various clustering techniques. So for example, it provides lists of most popular topics and most recent topics. It also identifies trends like ‘on the rise’, ‘on the fall’, and ‘steady’ topics.

The query difficulty prediction component and the content estimation component are based on machine learning techniques. The query difficulty prediction component is used to provide difficulty estimation for queries and topics, namely how difficult it is for the engine to come up with a highly and significantly ranked answer. The content estimation component is used for identifying missing content. For instance, it produces a list of topics which interest users but are not covered by the indexed documents.

The utility monitors the well-being of a search system along various dimensions in real time. System performance measures include: quality of search results, ease of use, result confidence level, failed queries, missing content, response time. The impact of changes made to the search engine and to the content of the collection can also be monitored and how the changes affect performance and effectiveness. Reports can be generated by the utility on query and content trends, and potential corrective measures for the search engine.

In addition, the utility can report recent and popular queries with specific attributes, for example, low recall, no recall, low scoring, all. Live monitoring of search engine basic performance can be carried out including query response time and query load. Also the manner by which users page through results can be identified.

The above monitoring aspects have the potential values of query difficulty insights, query trends analysis, content availability clues, sense of search engine performance, and quick link recommendations.

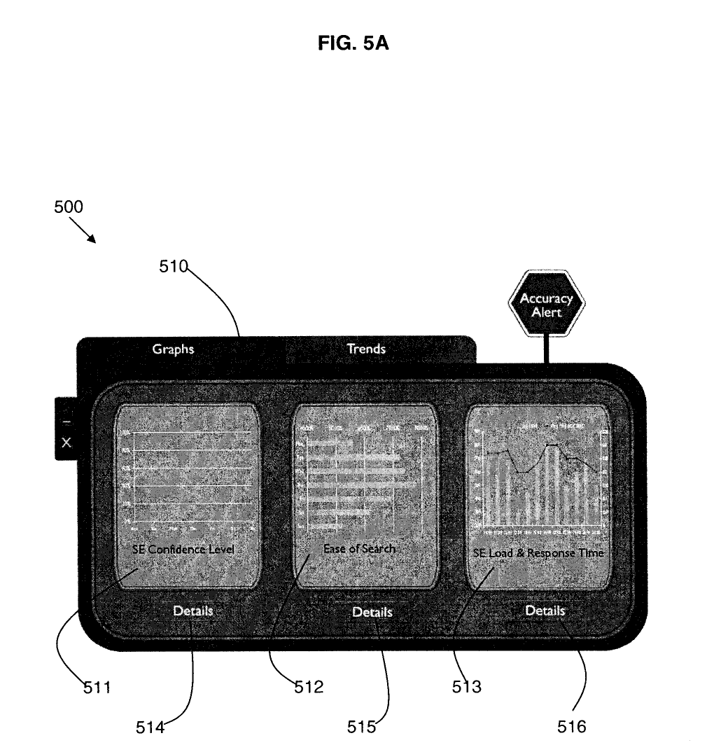

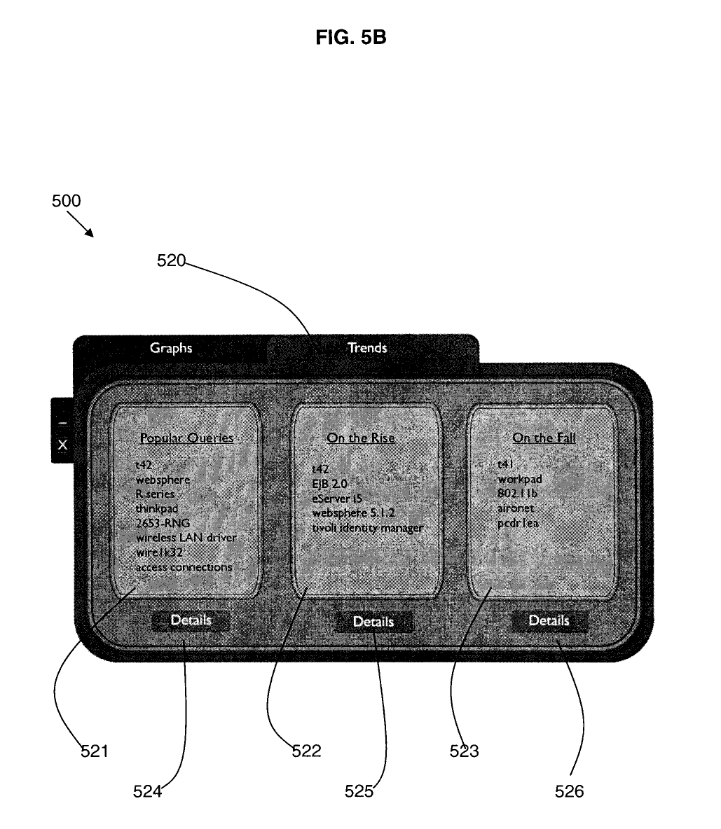

An example embodiment of a display interface 500 of an enterprise SE utility is provided with reference to FIGS. 5A and 5B. The display interface 500 embodiment includes a page of graphs 510 showing three graphs, a SE confidence level graph 511, an ease of search graph 512, and an SE load and response time graph 513. Further details of each of the graphs 511-513 can be displayed by selecting a button 514-516 adjacent the relevant graph 511-513.

The display interface 500 embodiment includes a page of trends 520 showing three aspects, popular queries 321, on the rise queries 322, and on the fall queries 323. Again further details of each of these trends 321-323 can be displayed by selecting a button 324-326 adjacent to the relevant trend 521-523.

There are many options for SE monitoring and this embodiment illustrates a variety of tools that suit the SE mediators' needs. This embodiment is based on the assumption that data, such as user query, user-session ID, results set, history log, and access to the index, can either be extracted from the SE or provided by the UI for continuous analysis. The following subsections give specific examples and solutions that address the abilities of the utility. Each subsection outlines the problem it addresses and the current solution to help solve this problem. There are many ways to solve each and every problem presented here and no attempt is made to present the best solution or the most sophisticated one.

SE Load Monitoring.

If a metaphor of a car dashboard is used, the easiest “speed” & “RPM” monitoring demonstration is to give the mediator a sense of SE load and response time. The SE may log timestamps for query requests and then display the analysis of the log in the desired fashion. In FIG. 5A, graph 513 shows this information analyzed to measure the hourly input of queries and the average response time of the engine. The bars in graph 513 indicate the number of queries and the red graph indicates average response time in seconds.

If the log of queries is detailed enough, then the utility may be able to suggest specific solutions to temporary load problems. For example in order to improve engine load, the utility may present the mediator with simple known steps that can be easily implemented. Such a suggestion may be that according to the analysis queries longer than X words reduce SE response time. It may be solved by displaying an example for shorter queries under the search box. Also, queries containing certain terms are very common within a user community but also common in the collection, therefore these queries take longer to process. The mediator may be presented with a suggestion to consider adding pre-determined links to the best answer page for the queries that occur often and also take longer to process. This may provide strong justification, that is engine-load dependent, to adding hard-coded links to certain popular queries.

Monitoring Query Difficulty and Search Confidence.

The SE confidence level shown in graph 511 of FIG. 5A measures the average confidence with which the SE answers user queries. The graph 511 indicates the percentage of queries that the engine considered “easy to answer” queries.

Query difficulty assessment is an attempt to estimate the ability of the SE to answer a given query. Queries may be rated difficult because they are too ambiguous, or because there is simply no good answer to the query in the indexed collection. This information can be used in the form of feedback to the SE administrators since it may be used as both a sanity check for query difficulty for the SE as well as providing a target function for optimizing queries. The SE mediators may choose to use different ranking functions for different queries based on their predicted difficulty, such as query expansion for “easy” queries or letter parsing for “difficult” queries.

By close analysis of the collection of queries that are rated difficult the utility may also be able to identify missing content. For example, the utility may generate a set of specific recommendations in order to improve on this aspect by following simple steps: “With the current settings your engine answers short queries better. Please encourage your users to submit shorter queries, e.g. by giving an example below the search box.” or “The most difficult queries to answer were found to be thinkpad 40s, and A31p cable problems. Consider analyzing the content associated with these queries and maybe create a direct link to answer them separately”.

Measuring Ease of Search

Ease of search measures the ability of the SE users to find what they are looking for through search. The bars in graph 512 of FIG. 5A indicate the percentage of users that fulfilled their information need i.e. found a satisfactory result, after a single query.

Ease of search may be measured by how many times a user needs to reformulate a query in order to receive the desired result set. Query reformulations are short “conversations” users conduct with the SE in order to achieve the best search results. A reformulation session begins with a user submitting a query, being unsatisfied with the result he then modifies subsequent queries until gaining satisfaction or realizing that the engine cannot provide a satisfactory answer. Query reformulations can thus be used for monitoring the user's ability to quickly find the information they need and consequently reflect the user's satisfaction with the SE.

Reformulation logs can additionally be used to provide insight into what users look for but cannot find. This duality addresses both search quality and content coverage. The analysis of query reformulations is therefore divided into two. The first, query reformulation rate, which may be directly represented in a chart as illustrated in graph 512 of FIG. 5A. This accounts for how satisfied the users are with the results after issuing a single query. A satisfied user is considered to be the one who needed only one query to receive a satisfactory set of results.

The second aspect, content enhancement, is a more rigorous analysis of the nature of the reformulations and their coupling with the content of the search results itself. For example, the mediator may be presented with specific suggestions for content improvement: “Many of the users who searched for airplane power supply, found it only after submitting the query: airplane power adapter. Consider adding the term supply to your descriptions”.

Another simple insight that the utility may provide an answer to is the problem of corporate jargon. For example, some users may query for “org charts” when the properly authored content is titled “organization charts”. Or “cert does” queried for content titled “certification documents”. Since the terms “org”, “cert”, and “does” are informal it is likely that they will not be used for describing the indexed content. A list of such corporate jargon terms may be automatically generated by the utility to be used within automatic query expansion lists or meta-information appended to relevant documents.

A more acute form of mediator intervention in the organization's content management may be exemplified by the following suggestion that can derive from the reformulation logs: “Some users repeatedly asked for linux openpower in more than three different variations but did not follow any of the results. This may provide an indication that a proper answer to this question is not found in your collection, or that relevant content is not searchable”. This requires the mediator to consult with the organization's content managers for a closer study of the content users are searching for and why a good answer is not found by the SE.

Query Trend Analysis

Query trend analysis is an important monitoring tool for SE mediators. Trends provide a glimpse into what users are searching for, where potential content authoring efforts should be made, which departments should be alerted for special interest in their product or support etc. This information can be used to create monthly reports to the enterprise's content managers regarding how queries about their content are ranked. These reports encourage content managers to improve the searchability of their content. FIG. 5B shows such trend lists in the envisioned utility.

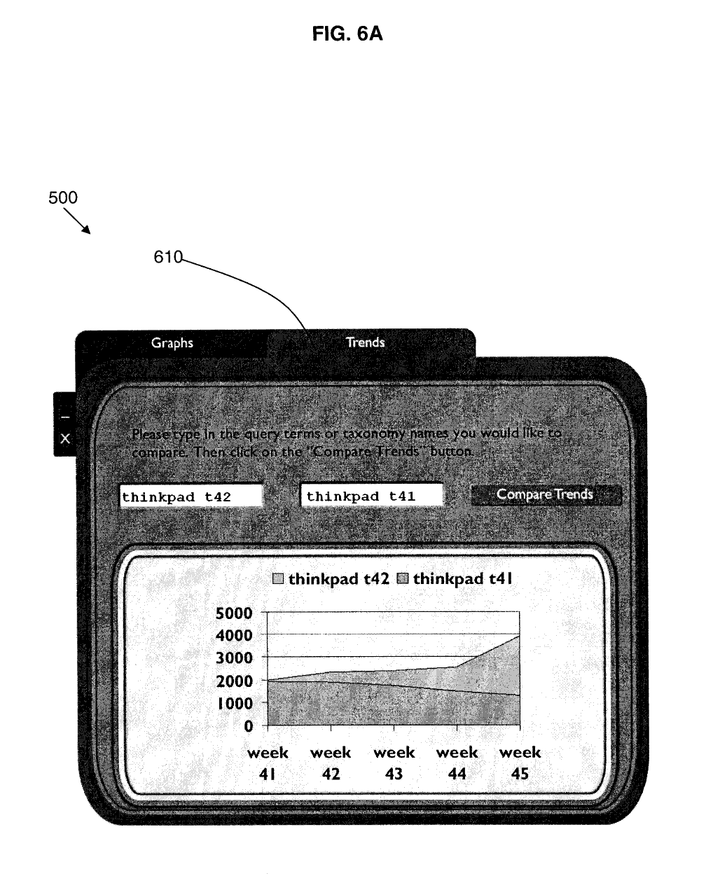

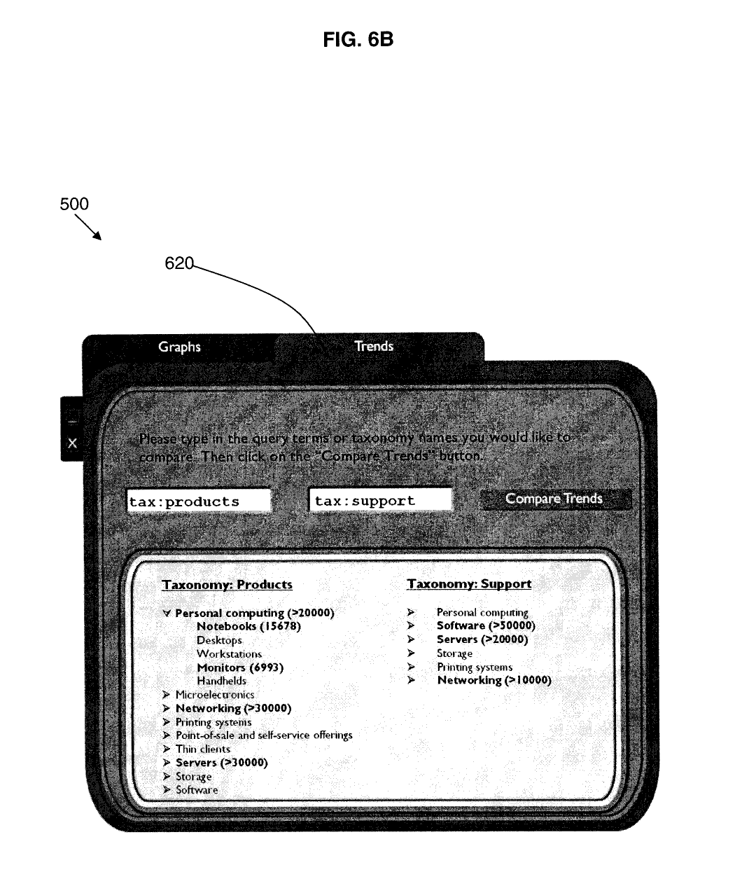

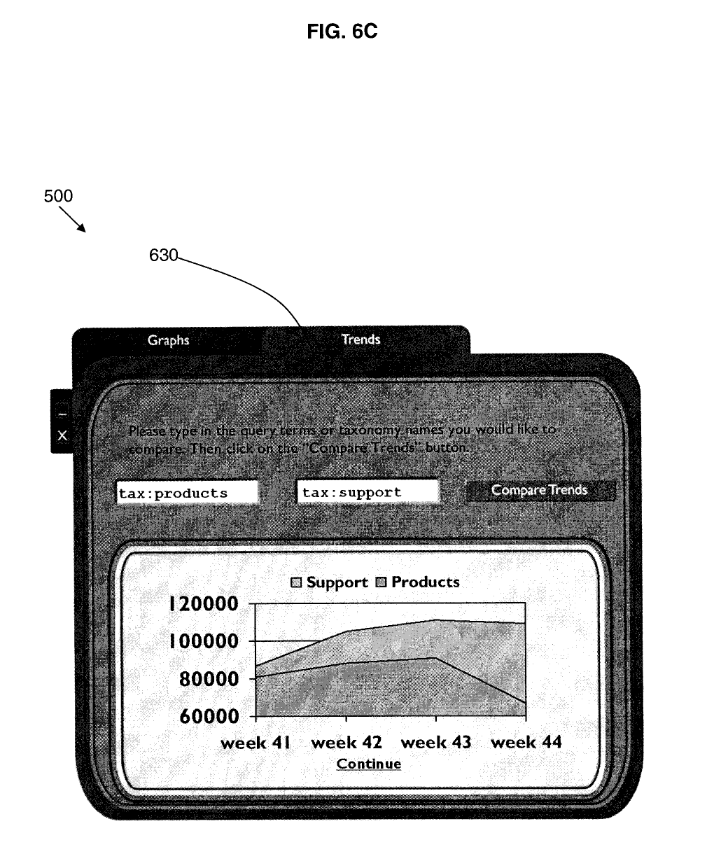

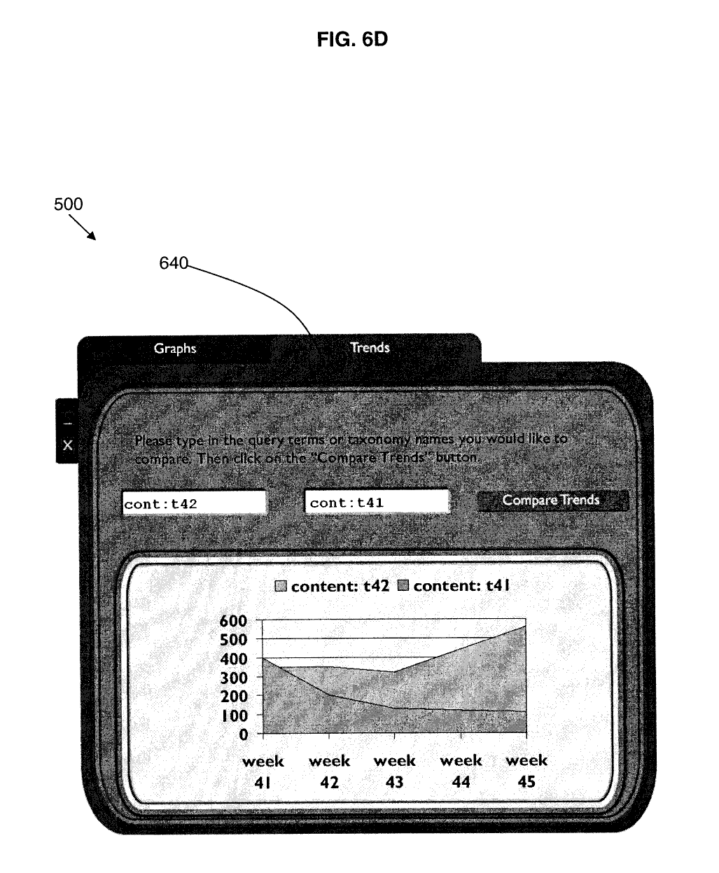

FIGS. 6A to 6D show a display interface 500 with more detailed trend analysis displays.

A more fine-tuned view of the envisioned query trend analysis interface 610 is shown in FIG. 6A where the trends of two queries 611, 612 are compared over time. This view may help mediators understand the gradual growth or decline of interest in certain queries, and vicariously the decline or rise in interest in certain subjects.

It is possible to use another enterprise content management tool to analyze query trends. FIG. 6B shows such an aggregated semantic mapping of queries onto enterprise taxonomy 620. This mapping shows different aspects of interest that may not be understood by merely analyzing the trends of the queries. Since many product oriented queries seem unrelated in a simple analysis, this aggregation assigns more power to the semantic meaning of a group of queries rather than to the single occurrence. This mapping also makes use of a very powerful content management tool and may be used to convey information 630 such as the one shown in FIG. 6C.

Content Trend Analysis

Comparing the searchable content with the search queries is one of the tasks SE mediators are responsible for. Monitoring the availability of searchable information for a particular query may provide preparation time for both the SE mediator and the content managers to author more relevant and up-to-date content that meets that users' needs; to crawl specific documents containing certain terms more frequently; to alert content managers of growing interest in a subject that has long been neglected, etc. The combination of the information 640 presented in FIG. 6D and the information 610 in FIG. 6A may help the enterprise content providers and the SE mediator collaborate for providing content that is more timely and tuned to the enterprise users' needs. The same comparison can be made by mounting the query-taxonomy mapping and content itself the same taxonomy. This will help identify gaps in the enterprise searchable content.

Sanity Checks

For every feature that is tracked, a record may be kept of normal activity scores and normal operation ranges. This information may be used to alert the SE mediator about deviations from the norm or when there is irregular system behavior.

In addition to those measures there are standard quality evaluation measures similar to the TREC (Text REtreival Conference) evaluation measures that can be applied to alert mediators about changes in the quality of the SE results. For example, the TREC measure relies on the provision of several search queries and a set of marked pages that answer those queries. The quality of the results is then tested based on the ability of the SE to return as many of the marked pages to a given query. This is a simple evaluation tool that can be maintained and controlled by the SE mediator.

The search quality problem can also be extended to examine both search quality and information coverage. One of the solutions is called Term Relevance Sets (Trels), which is a generic method for measuring the quality of the results returned by the SE. Generally, Trels consist of a list of terms believed to be relevant for a particular query as well as a list of irrelevant terms for that query. Trels measure the quality of returned results based on the results' content (appearance of some terms), rather than on the presence of certain documents in the top results. This allows for a very flexible evaluation tool that does not depend on the existence of certain documents within the collection and is thus insensitive to index changes. For example, if a document is found by the crawler and is indexed in one week, but the next version of the index contains a different document with identical content (a duplicate), the Trels-based measurements will not be affected.

These tools for sanity checks will be calculated by the utility in regular intervals (hourly, daily, monthly, etc.) to provide a simple overall warning within the utility set of tools.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A system for monitoring search performance and user interaction, comprising:
a plurality of monitoring components, each for dynamic monitoring of an aspect of searching a collection of documents;
an analyzer module for analyzing the dynamic monitoring and identifying problems or difficulties in the search performance or user interaction; and
an output providing information regarding the search performance and user interaction.

2. A system as claimed in claim 1, wherein output provides one or more of: reasoning, improvement suggestions, reports, problem alerts, graphical representation, query trend analysis, content availability indication, search engine performance level, direct link recommendations.

3. A system as claimed in claim 1, wherein the analyzer module compares the dynamic monitoring to benchmark search engine conduct and document collection state.

4. A system as claimed in claim 1, wherein the analyzer module carries out trend analysis of search queries, taxonomies, or searchable content.

5. A system as claimed in claim 4, wherein the trend analysis maps search terms onto a taxonomy.

6. A system as claimed in claim 4, wherein the trend analysis provides a temporal plot of content derived from search queries.

7. A system as claimed in claim 1, wherein the analyzer module of the system includes one or more of: recent item tracker, significant item tracker, global events queue, query clustering component, query difficulty predictor, content estimator, query reformulation session detector.

8. A system as claimed in claim 1, including a display interface presenting aspects of the output to a user and including user interrogation means.

9. A system as claimed in claim 1, wherein the system monitors an enterprise search system.

10. A search system comprising:
a search application;
a search engine;
a searchable collection;
a system for monitoring search performance and user interaction as claimed in claim 1.

11. A search system as claimed in claim 10, wherein the system for monitoring search performance and user interaction is local to the search application.

12. A search system as claimed in claim 10, wherein the system for monitoring search performance and user interaction is remote from the search application and receives inputs from one or more search applications, and the search engine.

13. A search system as claimed in claim 10, wherein the system includes an application programming interface (API) for inputting data into the system from one or more of: a search application and a search engine.

14. A search system as claimed in claim 13, wherein the API outputs data to one or more of a search application, a search engine, a graphical user interface (GUI), and a search administration application.

15. A search system as claimed in claim 12, wherein the system includes remote access capability and control.

16. A method for monitoring search performance and user interaction, comprising:
dynamic monitoring of a plurality of aspects of searching a collection of documents;
analyzing the dynamic monitoring and identifying problems or difficulties in the search performance or user interactions; and
providing information regarding the search performance and user interaction.

17. A method as claimed in claim 16, wherein the step of providing information provides one or more of: reasoning, improvement suggestions, reports, problem alerts, graphical representation, query trend analysis, content availability indication, search engine performance level, direct link recommendations.

18. A method as claimed in claim 16, wherein the step of monitoring includes measures of one or more of: quality of search results, ease of use, result confidence level, failed queries, missing content, response time, impact of changes to a search engine or collection content.

19. A computer program product stored on a computer readable storage medium, comprising computer readable program code means for performing the steps of:
dynamic monitoring of a plurality of aspects of searching a collection of documents;
analyzing the dynamic monitoring and identifying problems or difficulties in the search performance or user interactions; and
providing information regarding the search performance and user interaction.

20. A method of providing a service to a customer over a network for monitoring search performance and user interaction, the service comprising:
dynamic monitoring of a plurality of aspects of searching a collection of documents;
analyzing the dynamic monitoring and identifying problems or difficulties in the search performance or user interactions; and
providing information regarding the search performance and user interaction.
